(19) United States
(12) Patent Application Publication
(10) Pub. No.: US 2017/0372260 A1
(43) Pub. Date: Dec. 28, 2017

(54) ENVIRONMENTAL PARAMETER MONITOR WITH MACHINE READABLE DISPLAY

(71) Applicant: Carrier Corporation, Farmington, CT (US)

(72) Inventors: Richard Desmarais, Londonderry, NH (US); Jeffrey DiLuiso, Beverly, MA (US)

(21) Appl. No.: 15/538,256

(22) PCT Filed: Dec. 22, 2015
(86) PCT No.: PCT/US2015/067303

§ 371 Date: Jun. 21, 2017

Related U.S. Application Data
(60) Provisional application No. 62/096,577, filed on Dec. 24, 2014.

(51) Int. Cl. G06Q 10/08; G06K 19/06; B65D 79/02; G08B 21/18

(52) U.S. Cl. CPC G06Q 10/0832; G08B 21/18; G06K 19/06112; B65D 79/02; G06K 19/06037; G06K 19/06028; G06Q 10/087

(57) ABSTRACT

A method and system for cold chain monitoring of perishable goods includes at least one environmental sensor (102) to monitor at least one environmental parameter, a controller (104) to log a plurality of readings from each of the at least one environmental sensors (102), and a machine readable display (114) to display at least one alarm status associated with the plurality of readings via a barcode.

### FIELD OF THE INVENTION

The subject matter disclosed herein relates to environmental parameter monitoring, and to a system and a method for monitoring an alarm status via a machine readable display.

### DESCRIPTION OF RELATED ART

Typically, cold chain distribution systems are used to transport and distribute temperature sensitive and perishable goods. For example, food and pharmaceuticals may be susceptible to temperature, humidity, and other environmental factors. Advantageously, cold chain systems allow perishable and environmentally sensitive goods to be effectively transported and distributed without damage or other undesirable effects.

Environmental parameter sensors are often used in cold chain distribution systems to monitor the conditions and integrity of the cold chain and consequently the goods transported. Current environmental parameter sensing systems may log data to be retrieved at a later time, but may not communicate an alarm status or condition to other devices within the cold chain distribution system. A system and method that can provide real time monitoring of alarm conditions and status in transit via a machine readable display is desired.

### BRIEF SUMMARY

According to an embodiment of the invention, an apparatus for cold chain monitoring of perishable goods includes at least one environmental sensor to monitor at least one environmental parameter, a controller to log a plurality of readings from each of the at least one environmental sensors, and a machine readable display to display at least one alarm status associated with the plurality of readings via a barcode.

In addition to one or more of the features described above, or as an alternative, further embodiments could include that the barcode is a one dimensional barcode.

In addition to one or more of the features described above, or as an alternative, further embodiments could include that the barcode is a two dimensional bar code.

In addition to one or more of the features described above, or as an alternative, further embodiments could include that the barcode includes a static barcode portion.

In addition to one or more of the features described above, or as an alternative, further embodiments could include that the barcode includes a dynamic barcode portion associated with the plurality of readings.

In addition to one or more of the features described above, or as an alternative, further embodiments could include that the barcode includes at least one product identifier or at least one manufacturer identifier.

In addition to one or more of the features described above, or as an alternative, further embodiments could include that the at least one alarm status includes a last reading from the at least one environmental sensor.

In addition to one or more of the features described above, or as an alternative, further embodiments could include that the at least one alarm status includes an excursion alarm status.

According to an embodiment of the invention, a method for cold chain monitoring of perishable goods includes providing at least one environmental sensor, monitoring at least one environmental parameter via the at least one environmental sensor, logging a plurality of readings from each of the at least one environmental sensors via a controller, displaying a barcode associated with at least one alarm status associated with the plurality of readings via a machine readable display.

In addition to one or more of the features described above, or as an alternative, further embodiments could include that the barcode is a one dimensional barcode.

In addition to one or more of the features described above, or as an alternative, further embodiments could include that the barcode is a two dimensional bar code.

In addition to one or more of the features described above, or as an alternative, further embodiments could include that the barcode includes a dynamic barcode portion associated with the plurality of readings.

In addition to one or more of the features described above, or as an alternative, further embodiments could include that the barcode includes at least one product identifier or at least one manufacturer identifier.

In addition to one or more of the features described above, or as an alternative, further embodiments could include that the at least one alarm status includes a last reading from the at least one environmental sensor.

In addition to one or more of the features described above, or as an alternative, further embodiments could include that the at least one alarm status includes an excursion alarm status.

Technical function of the embodiments described above includes a machine readable display to display at least one alarm status associated with the plurality of readings via a barcode. Other aspects, features, and techniques of the invention will become more apparent from the following description taken in conjunction with the drawings.

### BRIEF DESCRIPTION OF THE SEVERAL VIEWS OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which like elements are numbered alike in the several FIGURES:

FIG. 1 illustrates a schematic view of an exemplary cold chain distribution system suitable for use with an embodiment of the invention;

FIG. 2 is a schematic view of an exemplary environmental parameter monitor in accordance with an embodiment of the invention; and

FIG. 3 is a flow diagram of a method of monitoring environmental parameters in accordance with an embodiment of the invention.

### DETAILED DESCRIPTION OF THE INVENTION

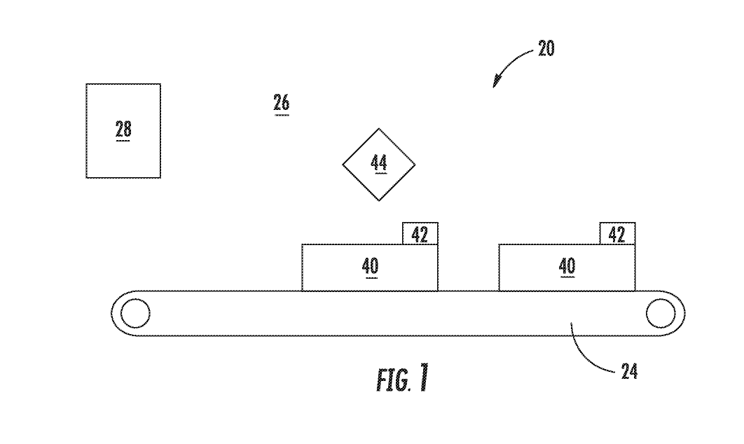

Referring now to the drawings, FIG. 1 illustrates a schematic view of an exemplary cold chain transportation or distribution system suitable for use with an environmental parameter monitor. In an exemplary embodiment, cold chain transportation system 20 includes a transport device 24, a controlled environment 26, perishable goods 40, environmental monitor 42, and barcode scanner 44. In an exemplary embodiment, the transport device is a conveyor belt or any other suitable transport device. It is understood that embodiments described herein may be applied to transport devices that are utilized within warehouses, loading docks, receiving docks, as well as shipping containers that are shipped by road, rail, sea, or any other suitable container. The transport device 24 may be in an controlled environment 26.

In an exemplary embodiment, environmental control system 28 is associated with transport device 24 to provide desired environmental parameters, such as temperature, humidity, CO₂ level, and other conditions to the controlled environment 26. In certain embodiments, environmental control system 28 is a refrigeration system capable of providing a desired temperature and humidity range. In an exemplary embodiment, perishable goods 40 are associated with an environmental monitor 42 subjected to the same environment as the perishable goods 40. In an exemplary embodiment, perishable goods 40 include food, drugs, or any other suitable goods requiring cold chain transport. The environmental monitor 42 may be placed in a variety of locations within controlled environment 26, including directly on the perishable goods 40.

In an exemplary embodiment, environmental monitor 42 monitors parameters and provides information via a display to a barcode scanner 44. In certain embodiments, barcode scanner 44 is a part of the existing logistical infrastructure of a cold chain operation. In certain embodiments, barcode scanner 44 is utilized for multiple functions including inventory control and tracking. In an exemplary embodiment, existing barcode scanner 44 is utilized to gather information from environmental monitors 42.

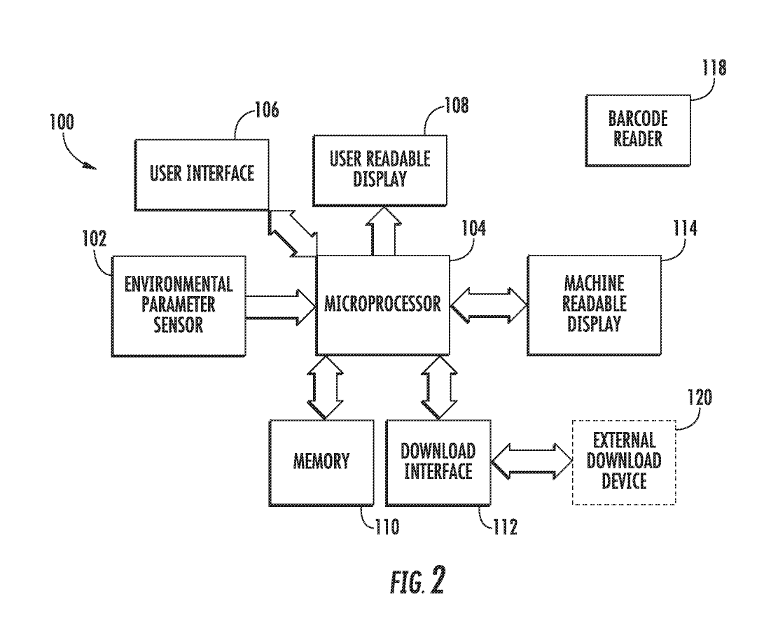

FIG. 2 shows an exemplary architecture of an environmental monitor 100. In an exemplary embodiment, environmental monitor 100 includes at least one environmental parameter sensor 102, a controller 104 (e.g., a microprocessor), and a machine readable display 114. Environmental monitor 100 may be used in cold chain operations and transportation as described in FIG. 1.

In an exemplary embodiment, at least one sensor 102 is utilized to monitor environmental parameters and generate a sensor reading. Environmental parameters may include position data, humidity, time, temperature, shock, vibration, ambient light, and gas emissions (such as carbon dioxide and ethylene). Accordingly, suitable sensors 102 are utilized to monitor the desired parameters. Advantageously, sensors 102 may be selected for certain applications depending on the perishable goods to be monitored and the corresponding environmental sensitivities. In an exemplary embodiment, temperatures are monitored. In certain embodiments, a user desires to maintain and monitor temperatures or other parameters within an acceptable range.

In an exemplary embodiment, readings from sensors 102 are received and processed by the controller 104. In an exemplary embodiment, readings from sensors 102 are received and logged in memory 110 during a desired monitoring period. In certain embodiments, the readings are further augmented with time, position stamps or other relevant information. Data logged in memory 110 may include a reading from sensor 102, whether the reading exceeds a (high or low) limit placed for a corresponding parameter, the sensed time and/or the sensed location.

The inclusion of controller 104 allows further analysis to be performed. In certain embodiments, controller 104 is programmed with or accepts predetermined ranges or limits for corresponding sensors 102. If a sensor 102 reading exceeds (a high or low) limit placed for a corresponding parameter, the time, place, and the sensor reading may be recorded. In certain embodiments, an alarm signal is displayed via machine readable display 114.

In certain embodiments, the data recorded to memory 110 is authenticated to prevent tampering of environmental data. The data in memory 110 may be signed, encrypted or otherwise authenticated. Advantageously, such authentication ensures the recorded data is accurate and allows an accurate assessment of recorded environmental conditions.

In an exemplary embodiment, controller 104 communicates with a barcode reader 118 via a machine readable display 114. Machine readable display 114 may display and barcode reader 118 may interpret any suitable machine readable symbologies, including, but not limited to one dimensional barcodes, two dimensional barcodes, etc. Two dimensional barcode symbologies may include data matrix, MaxiCode, PDF 41, PDF 417 Truncated, QR Code, Codablock F, Aztec Code, etc. In certain embodiments, barcodes can include human readable elements. Human readable elements may be selectively displayed or periodically displayed. In certain embodiments, barcode reader 118 can display information determined from machine readable display 114. In other embodiments, systems associated with barcode reader 118 can transmit and receive information provided by machine readable display 114.

Barcodes may contain transmissions of logged data or the analyzed data (including, but not limited to last known reading, alarm and excursion data, etc.) described above, which allows for real time monitoring of the relevant environmental parameters. In an exemplary embodiment, a barcode can reflect the viability of the perishable goods associated with the environmental monitor 100. In certain embodiments, additional supporting information and resources are provided by the barcode. For example, a barcode may provide a download link to a tracking or informational program associated with the environmental monitor 100. In an exemplary embodiment, a responsible party can monitor the sensors 102, any parameter excursions beyond predefined limits, and any alarm conditions via systems associated with barcode reader 118 or a barcode reader 118 interface. Additionally, a responsible party may monitor additional parameters not internally monitored by environmental monitor 100. In certain embodiments, the responsible party can make real time decisions about the perishable goods to avoid or minimize undesirable effects. In response to monitored parameters or an event of interest, such as a climate control failure or malfunction, a responsible party can provide instructions and decisions. Such decisions can include communication with a conveyor operator/transportation provider, preemptively rejecting goods, reporting a parameter excursion to a third party, rerouting perishable goods to an environmentally controlled storage facility and/or additional processing. In an exemplary embodiment, a barcode can communicate or facilitate a binary accept/reject determination.

In certain embodiments, portions of the barcode include static information, such as, but not limited to a manufacturer identifier of the environmental monitor, a manufacturer identifier of the product, product identifiers, shipping information, etc. In certain embodiments, a portion of the barcode includes dynamic information in addition to the static information, wherein the dynamic information includes variable environmental information or displays multiple environmental parameters described above. In certain embodiments, the entire barcode is a dynamic barcode that changes in response to variable environmental information or displays multiple environmental parameters.

In an exemplary embodiment, barcode readers 118 are utilized for multiple functions. Advantageously, many cold chain facilities currently utilize barcode scanner infrastructure for identification and other machine readable information. Accordingly, by providing alarm status and other environmental information via a machine readable interface such as machine readable display 114, current infrastructure and devices such as barcode reader 118 can be utilized to provide additional information and functionality.

In an exemplary embodiment, environmental monitor 100 includes a user interface 106 and user readable data display 108 to allow a user to directly and locally interact with environmental monitor 100. In an exemplary embodiment, environmental monitor 100 can display status information and relevant data points on display 108. In certain embodiments, user interface 106 allows a user to stop and start monitoring operations, as well as review data and alarm conditions. Advantageously, a local use and review of environmental monitor 100 can allow on-site review and determinations to be made regarding routing, storage and goods acceptance. In certain embodiments, user readable data display 108 can provide basic alarm status to a human user, while machine readable display 114 provides detailed information to barcode readers 118.

In an exemplary embodiment, a local interface 112 facilitates a secondary data download after the perishable goods have reached a checkpoint or a destination. Data may be transferred to an external download device 120. The locally downloaded data may be authenticated, provide additional data for diagnostic purposes or provide data in accordance with receiver/shipper protocols. The local interface 112 may transfer data by any suitable local method, including, but not limited to USB, serial transmission, optical transmission, local Wi-Fi, personal area networks, or any other suitable local interface.

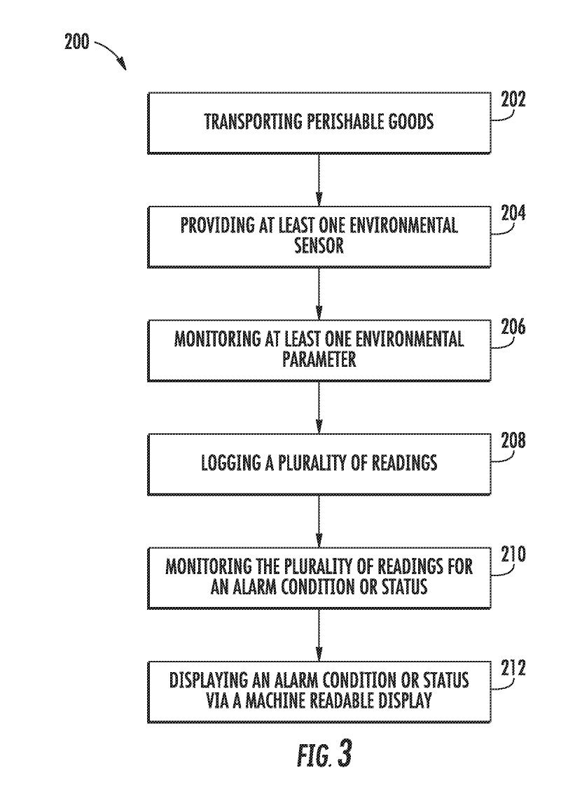

FIG. 3 illustrates an exemplary method 200 to monitor environmental parameters, particularly in a cold chain system. In operation 202, perishable goods, including perishable food and pharmaceuticals, are transported via a suitable cold chain transport.

In operation 204 a suitable environmental monitor 100 is placed to be associated with the perishable goods to monitor the environmental parameters the perishable goods are subjected to.

In operation 206, the parameters are monitored by the controller 104. Monitoring operations may sample at any frequency desired depending on sensitivity requirements and technical requirements. The controller 104 may include predefined parameter limits to determine alarm conditions in case of parameter excursion.

In operation 208, the readings from sensors 102 are logged in memory 110 for later review. Data logged in memory 110 may include sensor readings, time, position, alarms, and any other suitable information.

In operation 210 the data logged in memory 110 can be monitored for an alarm condition or excursion condition. In certain embodiments, the last known temperature, or other sensor reading is monitored to be displayed in operation 212.

In operation 212 a desired alarm condition, excursion condition, or status is displayed via a machine readable display 114. The information displayed on the machine readable display 114 may be read by a barcode scanner. The machine readable display 114 may show a static, partially dynamic, or fully dynamic barcode reflecting current conditions or status.

The terminology used herein is for the purpose of describing particular embodiments only and is not intended to be limiting of the invention. While the description of the present invention has been presented for purposes of illustration and description, it is not intended to be exhaustive or limited to the invention in the form disclosed. Many modifications, variations, alterations, substitutions or equivalent arrangement not hereto described will be apparent to those of ordinary skill in the art without departing from the scope and spirit of the invention. Additionally, while the various embodiments of the invention have been described, it is to be understood that aspects of the invention may include only some of the described embodiments. Accordingly, the invention is not to be seen as limited by the foregoing description, but is only limited by the scope of the appended claims.

1. An apparatus for cold chain monitoring of perishable goods, comprising:
at least one environmental sensor to monitor at least one environmental parameter;
a controller to log a plurality of readings from each of the at least one environmental sensors; and
a machine readable display to display at least one alarm status associated with the plurality of readings via a barcode.

2. The apparatus of claim 1, wherein the barcode is a one dimensional barcode.

3. The apparatus of claim 1, wherein the barcode is a two dimensional bar code.

4. The apparatus of claim 1, wherein the barcode includes a static barcode portion.

5. The apparatus of claim 1, wherein the barcode includes a dynamic barcode portion associated with the plurality of readings.

6. The apparatus of claim 1, wherein the barcode includes at least one product identifier or at least one manufacturer identifier.

7. The apparatus of claim 1, wherein the at least one alarm status includes a last reading from the at least one environmental sensor.

8. The apparatus of claim 1, wherein the at least one alarm status includes an excursion alarm status.

9. A method for cold chain monitoring of perishable goods, comprising:
providing at least one environmental sensor;
monitoring at least one environmental parameter via the at least one environmental sensor;
logging a plurality of readings from each of the at least one environmental sensors via a controller; and
displaying a barcode associated with at least one alarm status associated with the plurality of readings via a machine readable display.

10. The method of claim 9, wherein the barcode is a one dimensional barcode.

11. The method of claim 9, wherein the barcode is a two dimensional barcode.

12. The method of claim 9, wherein the barcode includes a dynamic barcode portion associated with the plurality of readings.

13. The method of claim 9, wherein the barcode includes at least one product identifier or at least one manufacturer identifier.

14. The method of claim 9, wherein the at least one alarm status includes a last reading from the at least one environmental sensor.

15. The method of claim 9, wherein the at least one alarm status includes an excursion alarm status.
